(19) United States
(12) Patent Application Publication
(10) Pub. No.: US 2025/0334726 A1
(43) Pub. Date: Oct. 30, 2025

(54) FILM-TYPE INFRARED BLOCKING OPTICAL FILTER AND MANUFACTURING METHOD THEREOF

(71) Applicant: OPTRONTEC CO., LTD, Daejeon (KR)

(72) Inventors: Dae Hyun Jeong, Seoul (KR); Jang Seob Kim, Daejeon (KR); Dung Gun Lee, Jeonbuk-do (KR); Sun Ho Cha, Daejeon (KR)

(73) Assignee: OPTRONTEC CO., LTD, Daejeon (KR)

(21) Appl. No.: 19/189,367

(22) Filed: Apr. 25, 2025

(30) Foreign Application Priority Data
Apr. 26, 2024 (KR) 10-2024-0056152
Mar. 14, 2025 (KR) 10-2025-0033427

(51) Int. Cl. G02B 5/20

(52) U.S. Cl. CPC G02B 5/208

(57) ABSTRACT

Disclosed are a film-type infrared blocking optical filter and a manufacturing method thereof. The filter includes: a film made of a polymer material; a first stacked filter disposed on a first surface of the film and blocking a first wavelength having a value within a range of 750 to 1150 nm; and a second stacked filter disposed on a second surface of the film and blocking a second wavelength having a value within a range of 800 to 950 nm.

### CROSS-REFERENCE TO RELATED APPLICATION(S)

This application is based on and claims priority under 35 U.S.C. § 119 to Korean Patent Application No. 10-2024-0056152, filed on Apr. 26, 2024, and Korean Patent Application No. 10-2025-0033427, filed on Mar. 14, 2025, in the Korean Intellectual Property Office, the disclosure of which are incorporated by reference herein in their entireties.

### BACKGROUND

### Field of the Disclosure

Apparatuses and methods consistent with the disclosure relate to a film-type infrared blocking optical filter and a manufacturing method thereof.

### Description of the Related Art

A light source processed by an optical filter may include light of various wavelengths. For example, sunlight may emit wavelengths such as visible light, infrared rays (IR), and ultraviolet rays (UV). A digital camera may selectively acquire the wavelengths by processing the same by using this optical filter (e.g., infrared blocking filter). However, during this processing process, light source blurring may occur if the camera captures an infrared light source by using the optical filter.

### SUMMARY

The disclosure provides an infrared blocking filter that selectively transmits light within a specific wavelength range and prevents light source blurring around the light source in case of capturing an infrared light source by using a solid-state imaging device.

The disclosure also provides an infrared blocking filter manufactured in a manner where each thickness of respective filter layers, disposed by interposing a base substrate therebetween, is not restricted to a predetermined standard (e.g., the same standard applied to stacked filters) while easily resolving light source blurring.

The disclosure also provides an infrared blocking filter manufactured in a manner where warping is prevented from occurring in respective filter layers, disposed by interposing a base substrate therebetween.

According to an embodiment of the disclosure, provided is a film-type infrared blocking the optical filter including: a film made of a polymer material; a first stacked filter disposed on a first surface of the film and blocking a first wavelength having a value within a range of 750 to 1150 nm; and a second stacked filter disposed on a second surface of the film and blocking a second wavelength having a value within a range of 800 to 950 nm.

The first stacked filter may have a transmittance of less than 5 at the first wavelength.

The second stacked filter may have a transmittance of less than 10 at the second wavelength.

The first stacked filter may include a first material having a refractive index of 2 or greater at the first wavelength, and a second material having a refractive index of 1.5 or less at the first wavelength.

The first material may include at least one of titanium dioxide (TiO₂), titanium(III) oxide (Ti₃O₅), or tantalum pentoxide (Ta₂O₅), and the second material may include at least one of silicon dioxide (SiO₂) or magnesium fluoride (MgF₂).

The second stacked filter may include a third material having a refractive index of 2 or greater at the second wavelength, a fourth material having a refractive index of 1.5 or less at the second wavelength, and a fifth material having a refractive index of 1.6 to 1.8 at the second wavelength.

The third material may include at least one of titanium dioxide (TiO₂), titanium(III) oxide (Ti₃O₅), or tantalum pentoxide (Ta₂O₅).

The fourth material may include at least one of silicon dioxide (SiO₂) or magnesium fluoride (MgF₂).

The fifth material may include aluminum oxide (Al₂O₃).

According to another embodiment of the disclosure, provided is a manufacturing method of film-type infrared blocking the optical filter, the method including: disposing a first stacked filter, which blocks a first wavelength having a value within a range of 750 nm or more (ex. 750 nm to 1150 nm), on a first surface of a film made of a polymer material; and disposing a second stacked filter, which blocks a second wavelength having a value within a range of 800 nm or more (ex. 800 nm to 950 nm), on a second surface of the film.

In addition, the optical filter may have an optical density greater than 4 within a wavelength having a value within a range of 750 to 950 nm.

As set forth above, the disclosure may provide the infrared blocking filter that is mounted on the camera module to selectively transmit light within the specific wavelength range, and may prevent the light source blurring around the light source in case of capturing the infrared light source by using the solid-state imaging.

In particular, the disclosure may provide the infrared blocking filter manufactured in a manner where each thickness of the respective filter layers, disposed by interposing the base substrate therebetween, is not pre-restricted to the predetermined specific standard (e.g., the same standard applied to each filter layer) while easily resolving the image blurring.

In addition, the disclosure may provide the infrared blocking filter manufactured in a manner where the warping is prevented from occurring in the respective filter layers, disposed by interposing the base substrate therebetween.

### BRIEF DESCRIPTION OF THE DRAWINGS

FIG. 1 is a diagram showing a configuration of a film-type infrared blocking optical filter according to at least one embodiment of the disclosure.

FIG. 2 is a diagram showing a configuration of the film-type infrared blocking optical filter according to at least one embodiment of the disclosure.

FIG. 3 is a diagram showing a configuration of the film-type infrared blocking optical filter according to at least one embodiment of the disclosure.

FIG. 4 is a diagram showing an example of a position of the film-type infrared blocking optical filter according to at least one embodiment of the disclosure.

FIG. 5 is a graph showing a characteristic value according to a comparative example related to the disclosure.

FIG. 6 is a graph showing a characteristic value according to the comparative example related to the disclosure.

FIG. 7 is a graph showing a characteristic value according to at least one embodiment of the disclosure.

FIG. 8 is a graph showing a characteristic value according to at least one embodiment of the disclosure.

FIG. 9 is a graph showing at least one embodiment of the disclosure together with the comparative example.

FIG. 10 is a drawing showing an image quality state according to the comparative example related to the disclosure.

FIG. 11 is a drawing showing an image quality state according to at least one embodiment of the disclosure.

FIG. 12 is a flow chart sequentially showing a manufacturing method of a film-type infrared blocking optical filter according to at least one embodiment of the disclosure.

### DETAILED DESCRIPTION OF THE PREFERRED EMBODIMENTS

General terms currently widely used are selected as terms used in various embodiments of the disclosure in consideration of their functions in the disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the disclosure. Therefore, the terms used in the disclosure need to be defined on the basis of the meanings of the terms and the contents throughout the disclosure rather than simple names of the terms.

In the specification, an expression “have,” “may have,” “include,” “may include,” or the like indicates the presence of a corresponding feature (for example, a numerical value, a function, an operation, or a component such as a part), and does not exclude the presence of an additional feature. An expression, “at least one of A or/and B” may indicate either “A or B”, or “both of A and B.”.

Expressions “first,” “second,” or the like used in the disclosure may qualify various components regardless of the sequence or importance of the components. These expressions are used only to distinguish one component and another component from each other, and do not limit the corresponding components.

A term of a singular number may include its plural number unless explicitly indicated otherwise in the context. It should be understood that a term “include,” “formed of,” or the like used in this application specifies the presence of features, numerals, steps, operations, components, parts, or combinations thereof, mentioned in the specification, and does not preclude the presence or addition of one or more other features, numerals, steps, operations, components, parts, or combinations thereof.

Hereinafter, an embodiment of the disclosure is described in more detail with reference to the accompanying drawings.

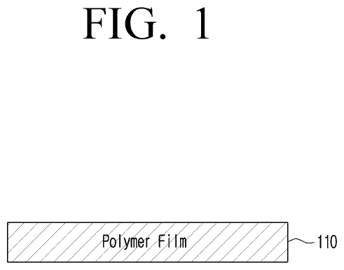

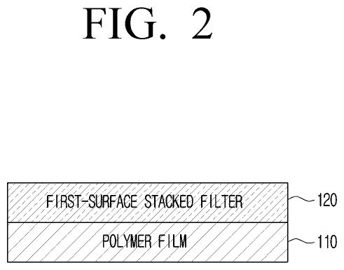

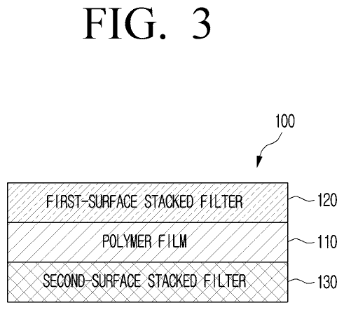

FIG. 1 is a diagram showing a configuration of a film-type infrared blocking optical filter according to at least one embodiment of the disclosure. FIG. 2 is a diagram showing another configuration of the film-type infrared blocking optical filter according to at least one embodiment of the disclosure. FIG. 3 is a diagram showing yet another configuration of the film-type infrared blocking optical filter according to at least one embodiment of the disclosure.

Referring to FIGS. 1, 2 and 3, a film-type infrared blocking optical filter 100 according to an embodiment of the disclosure may include a film 110, a first stacked filter 120 and a second stacked filter 130. The film 110 of the film-type infrared blocking optical filter 100 may be made of a polymer material.

The first stacked filter 120 of the film-type infrared blocking optical filter 100 may be disposed on a first surface of the film 110. The first stacked filter 120 of the film-type infrared blocking optical filter 100 may have a first wavelength having a value within a range of approximately 750 to 1150 nm.

The second stacked filter 130 of the film-type infrared blocking optical filter 100 may be disposed on a second surface of the film 110. The second stacked filter 130 of the film-type infrared blocking optical filter 100 may have a second wavelength having a value within a range of approximately 800 to 950 nm.

In particular, the first stacked filter 120 of the film-type infrared blocking optical filter 100 may have a transmittance of less than 5 at the first wavelength. The second stacked filter 130 may have a transmittance of less than 10 at the second wavelength.

The first stacked filter 120 of the film-type infrared blocking optical filter 100 may include a first material having a refractive index of 2 or greater at the first wavelength, or the like. The first stacked filter 120 may include a second material having a refractive index of 1.5 or less at the first wavelength.

In addition, the first material in the first stacked filter 120 may include at least one of titanium dioxide (TiO₂), titanium(III) oxide (Ti₃O₅), or tantalum pentoxide (Ta₂O₅). The second material in the second stacked filter 130 may include at least one of silicon dioxide (SiO₂) or magnesium fluoride (MgF₂).

Here, the second stacked filter 130 may include a third material, a fourth material, a fifth material, or the like. The third material in the second stacked filter 130 may have a refractive index of approximately 2 or greater at the second wavelength.

The fourth material in the second stacked filter 130 may have a refractive index of approximately 1.5 or less at the second wavelength. The fifth material in the second stacked filter 130 may have a refractive index of approximately 1.6 to 1.8 at the second wavelength.

In more detail, the third material in the second stacked filter 130 may include at least one of TiO₂, Ti₃O₅, or Ta₂O₅. The fourth material in the second stacked filter may include at least one of SiO₂ or MgF₂. The fifth material in the second stacked filter 130 may include aluminum oxide (Al₂O₃).

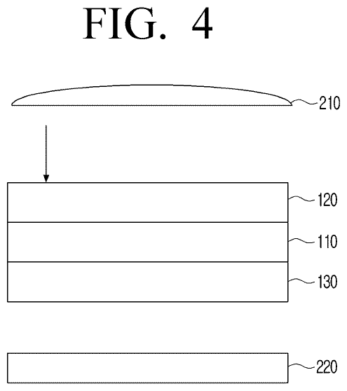

FIG. 4 is a diagram showing an example of a position of the film-type infrared blocking optical filter according to at least one embodiment of the disclosure. Referring to FIG. 4, the infrared blocking optical filter 100 according to the disclosure may be disposed between the lens 210 and image sensor 220 of a digital camera.

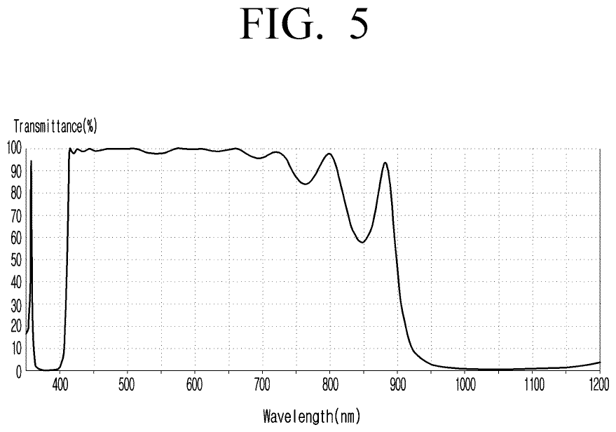

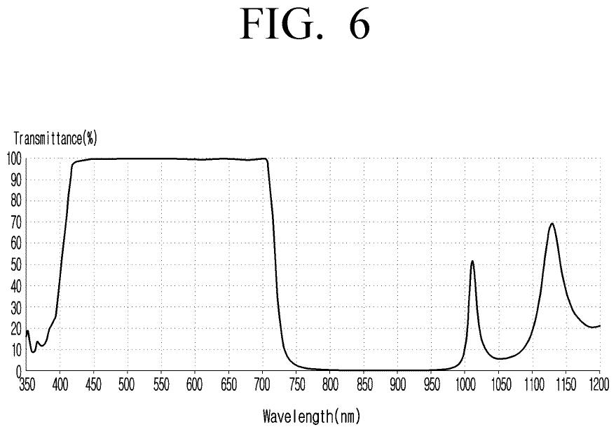

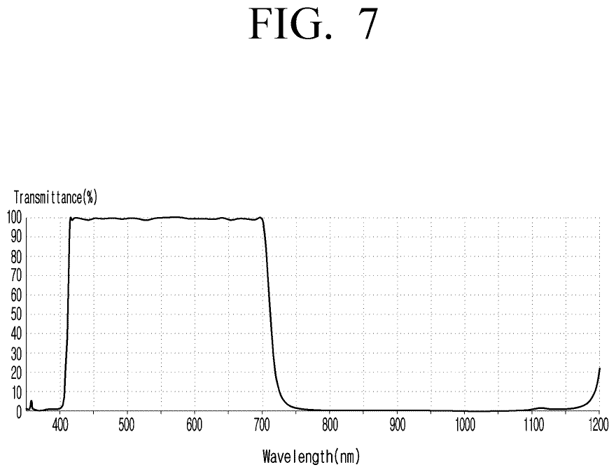

FIG. 5 is a graph showing a characteristic value according to a comparative example related to the disclosure. FIG. 6 is a graph showing a characteristic value according to the comparative example related to the disclosure. FIG. 7 is a graph showing a characteristic value according to at least one embodiment of the disclosure.

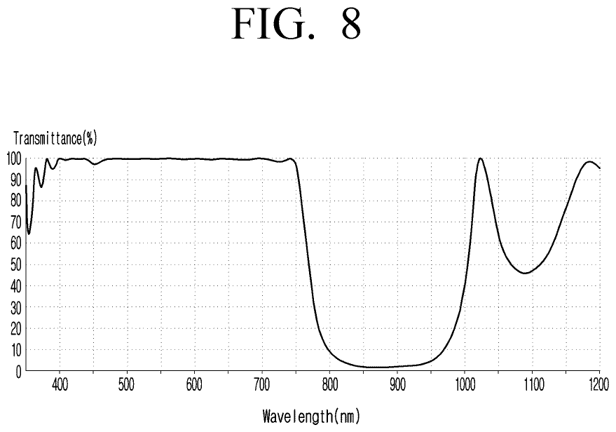

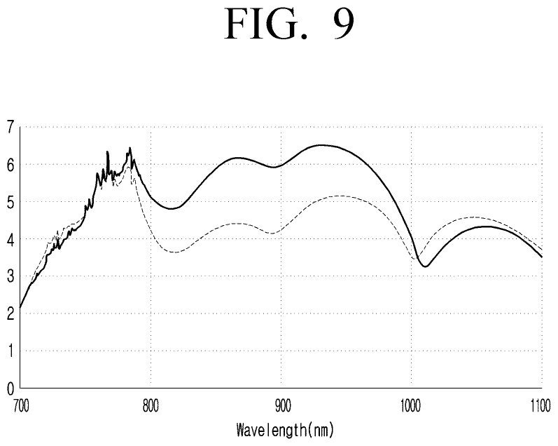

FIG. 8 is a graph showing a characteristic value according to at least one embodiment of the disclosure. FIG. 9 is a graph showing at least one embodiment of the disclosure together with the comparative example.

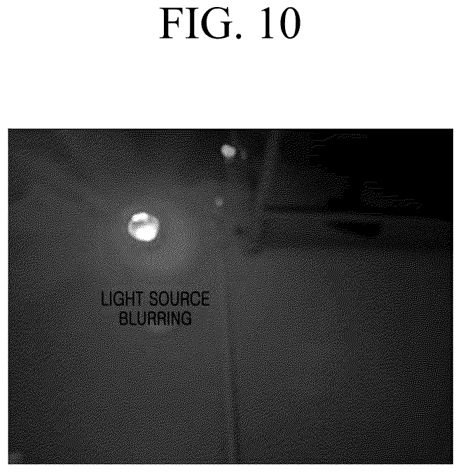

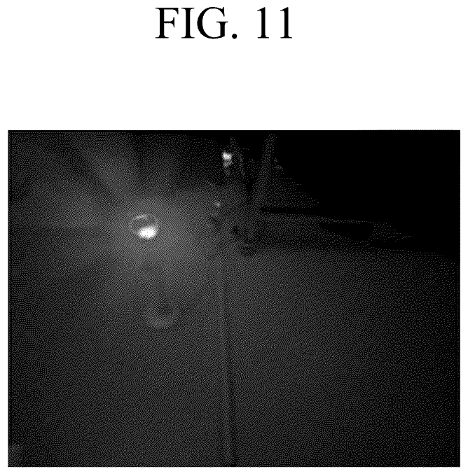

FIG. 10 is a drawing showing an image quality state according to the comparative example related to the disclosure. FIG. 11 is a drawing showing an image quality state according to at least one embodiment of the disclosure.

Hereinafter, the description describes at least one embodiment of the disclosure in more detail with reference to Tables 1 and 2 below along with FIGS. 5 to 10.

Table 1 is a table showing a comparison of the transmittance for each wavelength of the first and second stacked filters 120 and 130 according to an inventive example with that of the first and second stacked filters 120 and 130 according to the comparative example. Table 2 is a table showing a comparison of the optical density of the film-type infrared blocking optical filter 100 manufactured according to the comparative example with that of the film-type infrared blocking optical filter 100 manufactured according to the inventive example.

TABLE 1

| | | | Wavelength (nm) | | | | | | | |
|---|---|---|---|---|---|---|---|---|---|---|
| Division | | | 750 | 800 | 850 | 900 | 950 | 1000 | 1100 | 1200 |
| Inventive | First | Transmittance(%) | 1 | 0 | 0 | 0 | 0 | 0 | 1 | 1 |
| example | stacked | | | | | | | | | |
| | filter | | | | | | | | | |
| | Second | | 100 | 9 | 3 | 2 | 5 | 60 | 95 | 95 |
| | stacked | | | | | | | | | |
| | filter | | | | | | | | | |
| Comparative | First | | 90 | 58 | 59 | 59 | 4 | 0 | 0 | 5 |
| example | stacked | | | | | | | | | |
| | filter | | | | | | | | | |
| | Second | | 3 | 1 | 0 | 0 | 0 | 6 | 19 | 21 |
| | stacked | | | | | | | | | |
| | filter | | | | | | | | | |

TABLE 2

Wavelength (nm)

| | | | |
|---|---|---|---|
| Division | 800 | 900 | 1000 |

| | | | | |
|---|---|---|---|---|
| Inventive example | Optical Density | 5.1 | 5.9 | 4 |
| Comparative | | 3.9 | 4.2 | 3.4 |
| example | | | | |

### Inventive Example

The manufacturing of the film-type infrared blocking optical filter 100 in the disclosure is not limited to a specific method, and a portion of the filter may be manufactured by referring to various methods for manufacturing the infrared blocking optical filter 100, which are generally known in this field.

Referring to Tables 1 and 2 and FIGS. 7 and 8, the first stacked filter 120 described above is manufactured to have a transmittance of less than approximately 5 at the wavelength having a value within a range of approximately 750 to 1150 nm. In addition, the second stacked filter 130 is manufactured to have a transmittance of less than approximately 10 at the wavelength having a value within a range of approximately 800 to 950 nm.

In the inventive example, the optical density may have a value greater than approximately 4 at a wavelength having a value within a range of approximately 750 to 950 nm, and a higher optical density in the corresponding wavelength range may more effectively prevent blurring (flaring) of an infrared light source.

In addition, in the inventive example, the first stacked filter 120 may include a material such as TiO₂, Ti₃O₅, or Ta₂O₅ having the refractive index of approximately 2 or greater. In addition, the first stacked filter 120 may include a material such as SiO₂ or MgF₂ having the refractive index of approximately 1.5 or less.

The second stacked filter 130 may include at least one of the first material having the refractive index of approximately 2 or greater, the second material having the refractive index of approximately 1.5 or less, or the third material having the refractive index of approximately 1.6 to 1.8.

Here, the first material may include at least one of TiO₂, Ti₃O₅, or Ta₂O₅. The second material may include at least one of SiO₂ or MgF₂. In addition, the third material may include Al₂O₃.

The optical density according to the inventive example has a value greater than approximately 4 at the wavelength having a value within a range of approximately 750 to 950 nm. Referring to FIG. 11, it may be confirmed that at least one embodiment of the disclosure has a high optical density value within the corresponding wavelength range, thereby preventing the blurring (flaring) of the infrared light source.

### Comparative Example

Referring to Tables 1 and 2 and FIGS. 5 and 6, the first stacked filter 120 according to the comparative example is manufactured to have a transmittance of approximately 5 or less at a wavelength of approximately 950 to 1200 nm. The second stacked filter 130 is manufactured to have the transmittance of approximately 5 or less at the wavelength of approximately 750 to 950 nm.

The film-type infrared blocking optical filter 100 according to the comparative example needs to be manufactured to have characteristics shown in Table 1 to minimize the occurrence of warping in the first stacked filter 120 or the second stacked filter 130.

In addition, to manufacture a total thickness of the first stacked filter 120 and the second stacked filter 130 to be similar, the filters need to be manufactured to have the characteristics shown in Table 1.

In addition, due to the warping and thickness issues, each thickness of the first stacked filter 120 and the second stacked filter 130 needs to be approximately 1.5 μm or more. Referring to FIG. 10, it may be confirmed that, in the comparative example, the optical density within the corresponding wavelength range is lower than that of the inventive example, and accordingly, the blurring (flaring) of the infrared light source occurs.

### Light Source Blurring

The inventive example and the comparative example described above have differences in their characteristic values shown in FIG. 9, respectively. Accordingly, as shown in FIG. 10, it may be confirmed that, in the comparative example, the light source blurring occurs during solid-state imaging by the digital camera. In contrast, as shown in FIG. 11, it may be confirmed that, in the inventive example described above, the light source blurring is removed.

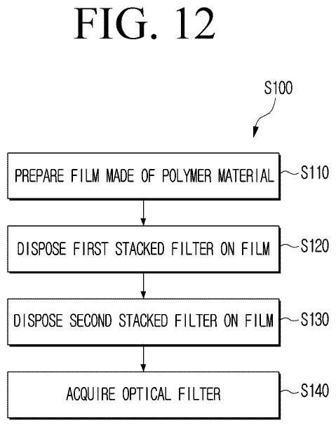

FIG. 12 is a flow chart sequentially showing a manufacturing method of a film-type infrared blocking optical filter according to an embodiment of the disclosure. Referring to FIG. 12, the manufacturing method of a film-type infrared blocking optical filter (S100) according to an embodiment of the disclosure may include steps S110, S120, and S130.

In S110, a substrate may be prepared. The substrate may correspond to the film 110 made of the polymer material, or the like. In S120, the first stacked filter 120, which blocks the first wavelength of approximately 750 nm or more, may be disposed on the first surface of the film 110. In S130, the second stacked filter 130, which blocks the second wavelength of approximately 800 nm or more, may be disposed on the second surface of the film 110.

The film-type infrared blocking optical filter 100 manufactured by following steps S110, S120, and S130 may have the optical density greater than approximately 4 at the wavelength having a value within a range of approximately 750 to 950 nm. Meanwhile, the aforementioned S120 and S130 may be performed sequentially or non-sequentially relative to each other and are not limited to any specific order.

In S140, The film-type infrared blocking optical filter 100 may be acquired an optical filter.

Although the disclosure has been described with reference to the accompanying drawings, the scope of the disclosure is not construed as being limited to the described embodiments and/or drawings, but is defined by the appended claims. In addition, it should be clearly understood that the improvements, changes, and modifications of the disclosure as described in the claims, which are obvious to those skilled in the art, are included in the scope of the disclosure.

What is claimed is:

1. A film-type infrared blocking optical filter comprising:
a film made of a polymer material;
a first stacked filter disposed on a first surface of the film and blocking a first wavelength having a value within a range of 750 to 1150 nm; and
a second stacked filter disposed on a second surface of the film and blocking a second wavelength having a value within a range of 800 to 950 nm.

2. The filter as claimed in claim 1, wherein the first stacked filter has a transmittance of less than 5 at the first wavelength.

3. The filter as claimed in claim 1, wherein the second stacked filter has a transmittance of less than 10 at the second wavelength.

4. The filter as claimed in claim 1, wherein the first stacked filter includes a first material having a refractive index of 2 or greater at the first wavelength.

5. The filter as claimed in claim 4, wherein the first material includes at least one of titanium dioxide (TiO₂), titanium(III) oxide (Ti₃O₅), or tantalum pentoxide (Ta₂O₅).

6. The filter as claimed in claim 1, wherein the first stacked filter includes a second material having a refractive index of 1.5 or less at the first wavelength.

7. The filter as claimed in claim 6, wherein the second material includes at least one of silicon dioxide (SiO₂) or magnesium fluoride (MgF₂).

8. The filter as claimed in claim 1, wherein the second stacked filter includes a third material having a refractive index of 2 or greater at the second wavelength.

9. The filter as claimed in claim 8, wherein the third material includes at least one of titanium dioxide (TiO₂), titanium(III) oxide (Ti₃O₅), or tantalum pentoxide (Ta₂O₅).

10. The filter as claimed in claim 1, wherein the second stacked filter includes a fourth material having a refractive index of 1.5 or less at the second wavelength.

11. The filter as claimed in claim 10, wherein the fourth material includes at least one of silicon dioxide (SiO₂) or magnesium fluoride (MgF₂).

12. The filter as claimed in claim 1, wherein the second stacked filter includes a fifth material having a refractive index of 1.6 to 1.8 at the second wavelength.

13. The filter as claimed in claim 12, wherein the fifth material includes aluminum oxide (Al₂O₃).

14. A manufacturing method of a film-type infrared blocking optical filter, the method comprising:
disposing a first stacked filter, which blocks a first wavelength having a value within a range of 750 nm or 1150 nm, on a first surface of a film made of a polymer material; and
disposing a second stacked filter, which blocks a second wavelength having a value within a range of 800 nm or 950 nm, on a second surface of the film.
